(19) United States
(12) Patent Application Publication
(10) Pub. No.: US 2007/0143591 A1
(43) Pub. Date: Jun. 21, 2007

(54) Method for non-destructive restoration of a corrupted operating system

(76) Inventor: Richard Dellacona, Corona Del Mar, CA (US)

Correspondence Address: PATENT LAW & VENTURE GROUP, 2424 S.E. BRISTOL, SUITE 300, NEWPORT BEACH, CA, 92660, US

(21) Appl. No.: 11/710,330

(22) Filed: Feb. 23, 2007

(51) Int. Cl. G06F 9/00; G06F 15/177

(52) U.S. Cl. 713/2

(57) ABSTRACT

A method for checking a computer's operating system for corruption and for de-corrupting it takes the steps of: loading a copy of an original operating system onto a second partition on the main drive, adapting the copy of the original operating system to the existing hardware configuration, restarting the computer from the copy of the original operating system, comparing the existing operating system on the first partition with the copy of the original operating system on the second partition so as to detect corrupted portions of the existing operating system, overwriting each of the corrupted portions of the existing operating system with each corresponding portion of the copy of the original operating system, restarting the computer from the existing operating system and rendering the first partition on the main drive as active before restarting the computer.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTTED ON A COMPACT DISC

Not applicable. REFERENCE TO A “MICROFICHE APPENDIX”

Not applicable.

### BACKGROUND OF THE INVENTION

1. Field of the Present Disclosure

This disclosure relates generally to methods for finding and repairing or deleting corruptions in data and programs stored in a computer and particularly relates to a method for restoring a corrupted operating system of the computer.

2. Description of Related Art Including Information Disclosed Under 37 CFR 1.97 and 1.98

The standard approach to cleaning up corrupted or compromised data (programs and data) is to compare the data in question to a known list of malicious data (code, viruses, worms, Trojan horses, etc.) stored in a database. The comparison is made and the matched malicious data is deleted. A limitation of this approach is the “zero day exploit.” This occurs when a new piece of malicious code is released into the pubic network but is not on any list of known malicious code. This code is impossible to identify and delete. In the case where this code migrates to a program on a optical disk (CD), for instance and installed into a computer that is not connected to the Internet, an existing “anti-virus” program on that computer is not able to recognize the infection or deal with it.

So-called “clean-up programs” are loaded onto an existing operating system. If the operating system is infected, as in the case of a root kit exploit, it cannot modify itself even if the root kit could be detected. The computer's operating system cannot modify itself while it is running.

The root kit is the hardest exploit to detect. It is a type of malicious code that is disguised to look like part of an operating system. It becomes a working part of the operating system and is undetectable because it looks exactly like the files that are parts of the operating system they replace. If you can detect these root kits, the only way to guarantee removal is to reformat the hard drive and reload all applications.

The following prior art references address these issues:

Childs, et al, 20050114411, discloses a method, computer program product and system for restoring previously un-backed up data during a system restore. A computing system may include a locked partition in its storage medium to store an alternate operating system and backed-up files. The alternate operating system may determine which files have been modified since the most recent backup and run a virus scan on those modified files. The alternate operating system may copy the modified files with no detected viruses as well as those modified files with a detected virus but cleaned by the virus scan. The backup files in the locked partition that have been modified since the most recent backup operation may be replaced with these uncorrupted modified files. In this manner, the system may be able to recover files since the most recent backup while ensuring at least in part that the restored files do not contain any viruses.

Rui et al, 20060069902, discloses a recovery method comprising the step of (a) preparing an optical disc which comprises a small operating system, a recovery utility program, and recovered computer operating system/application program/user data; (b) starting the optical disc to run the small operating system and the recovery utility program in the computer, creating a recovery partition on a local hard disk drive of the computer after the execution, formatting the recovery partition, copying the small operating system, recovery utility program, pre-compressed operating system/application program/user data to the recovery partition, and setting the recovery partition as the booting partition; (c) booting the computer from the recovery partition to execute the small operating system and the recovery utility program in the recovery partition of the computer as to create and format a user partition on the local hard disk drive after the execution, and recovering the compressed operating system/application program/user data in the recovery partition to the user partition; (d) booting the computer from the local hard disk drive, such that the computer is selected to enter into the user partition to execute the computer operating system/application program/user data or the computer is selected to enter into the recovery partition to execute the recovery utility program, and then restore the compressed operating system/application program/user data to the user partition, wherein users are allowed to choose whether or not to save the current existing data of the user partition when recovering the user partition.

Du, et al, 20070011493, discloses a method for restoring a computer operation system comprising backing up information related to start up of the computer in an HPA of a hard disk; providing a self-checking module in the HPA of the hard disk, and additionally configuring a command for invoking the self-checking module in BIOS of the computer; invoking the self-checking module by the BIOS when the computer is booted from the hard disk, and determining by the self-checking module, whether the information related to start up of the computer is destroyed or not, if so, restoring the destroyed parts and then starting up the computer, and if not, directly starting up the computer. With the present invention, each time the computer is booted from the hard disk, the system will automatically check OS boot program files, hard disk boot information, partition table information and data information in a boot sector of a boot partition, and restore those destroyed parts without users' intervention, and thus it facilitates users' utilizations. Meanwhile, the backed up data are stored with the HPA, and the security of the backed up data is ensured.

Goodman, et al, U.S. Pat. No. 7,146,640, discloses an intrusion secure personal computer system including a central processing unit, a data storage means, a memory means, a primary operating system, a virtual machine operating system providing an isolated secondary operating environment functioning separate from the primary operating system and controlling operations of the personal computer system within the isolated secondary operating environment and at least one input/output (I/O) connection in operative communication with an external data source, where the personal computer system is secured from malicious code contained in a file downloaded from the external data source.

Muttik, U.S. Pat. No. 6,775,780 discloses a system for determining whether software is likely to exhibit malicious behavior by analyzing patterns of system calls made during emulation of the software. The system operates by emulating the software within an insulated environment in a computer system so that the computer system is insulated from malicious actions of the software. During the emulation process, the system records a pattern of system calls directed to an operating system of the computer system. The system compares the pattern of system calls against a database containing suspect patterns of system calls. Based upon this comparison, the system determines whether the software is likely to exhibit malicious behavior. In one embodiment of the present invention, if the software is determined to be likely to exhibit malicious behavior, the system reports this fact to a user of the computer system. In one embodiment of the present invention, the process of comparing the pattern of system calls is performed on-the-fly as the emulation generates system calls.

Weber, U.S. Pat. No. 6,067,618, discloses a computer system including several nonconcurrently active hard disk drives ordinarily loaded with unique software bundles. Each active hard drive introduces an special operating system setup and applications installation which is unconditionally denied access by activities obtained under another hard disk drive's software instructions. An absolute isolation between two or more user's application programs and data files is achieved while sharing a common set of computer system hardware and peripherals. Each category of nonconcurrent user operates independently without a threat of corruption from activities of another prior or subsequent user utilizing the same computer system for another disparate activity. In an IDE/ATA interface environment, a typical arrangement includes a setting of ROM-BIOS to only recognize a MASTER drive with a subsequent user determined swapping of MASTER and SLAVE modes between at least two hard drives utilizing a manual switch-over to obtain operation under operating system and programs uniquely installed on each of the intently selected MASTER drives, while denying access to the alternant SLAVE drive. In an SCSI interface environment, several drives set with the same SCSI-ID number are selected between by manually controlling a completion of the SCSI bus SEL line to the active intended drive and interrupting the SEL line to designated inactive drives. Virus corruption of one primary drive is fire-walled against inadvertent transfer into an alternate primary drive thereby assuring system operating integrity for one user category in spite of virus contamination, command errors, or careless or malicious hacking introduced by another user category.

Draves, U.S. Pat. No. 5,802,590, discloses a method and system for allowing processes to access resources. A kernel of an operating system maintains a system-wide resource table. This resource table contains resource entries. When a resource is allocated, the kernel generates a key for the resource. The key is a very large number so as to prevent a malicious process from gaining unauthorized access to the resource. The kernel also hashes the key to generate an index into the resource table that is used as a handle. The kernel stores the key in a resource entry that is indexed by the handle. The handle.backslash.key pair is sent to a process. The process accesses the resources by passing handle.backslash.key pairs to the kernel. The kernel compares the passed key with a key that is stored in the resource entry referenced by the passed handle. When the stored key and the passed key match, the process is allowed to access the resource. When the stored key and the passed key do not match, the kernel rehashes the passed key to generate a new handle. The kernel then searches starting at the index of the new handle for a resource entry with a key that matches the passed key. When a key matches the passed key, the process is allowed to access the resource, and the index for the resource entry is returned to the process so that the process can use the index as a handle to access the resource on subsequent resource access requests. When the passed key does not match a key, the process is denied access to the resource.

Blaser, et al, U.S. Pat. No. 7,165,260, discloses a computer system having facilities for providing virtual portions of file systems and configuration settings to applications. More particularly, the inventions relate to computer systems that provide a layer organization for files and configuration settings that can be overlaid on top of an operating system, and can later delete the layer organization to restore the computer systems to a clean state.

Merrill, et al, U.S. Pat. No. 6,393,560, discloses a method whereby an operating system may be more efficiently initiated and restarted by making a virtual image of the configuration settings for a base system configuration. These settings may be stored and may be used to quickly initiate the system in its base configuration, for example, using an executive. The base configuration may be automatically modified in response to system hardware or software configuration changes. These changes may be stored with the base configuration information. When a crash occurs, the virtual image may be used to quickly restore the system without the necessity for rebooting the operating system.

The related art described above discloses methods for dealing with corruptions such as viruses, worms and Trojan horses including teaching methods for dealing with damage to the operating system of computers. However, the prior art fails to disclose the simple and highly effective method of the present invention. The present disclosure distinguishes over the prior art providing heretofore unknown advantages as described in the following summary.

### BRIEF SUMMARY OF THE INVENTION

This disclosure teaches certain benefits in construction and use which give rise to the objectives described below.

One of the hardest corruptions of the software in a computer to deal with is that of the operating system. This is because, with the computer operating from the operating system, it is impossible to repair the operating system. The present invention is a method for checking a computer's operating system for corruption and for restoring it. This method includes: loading a copy of an original operating system onto a second partition on the main drive, adapting the copy of the original operating system to the existing hardware configuration, restarting the computer from the copy of the original operating system, comparing the existing operating system on the first partition with the copy of the original operating system on the second partition so as to detect corrupted portions of the existing operating system, overwriting each of the corrupted portions of the existing operating system with each corresponding portion of the copy of the original operating system, maintaining a log of the corrupted portions, restarting the computer from the existing operating system and rendering the first partition on the main drive as active before restarting the computer.

A primary objective inherent in the above described apparatus and method of use is to provide advantages not taught by the prior art.

Another objective is check an operating system for corrupted files.

A further objective is to provide a method for cleaning corrupted files within an operating system.

A still further objective is to provide a method for more easily checking the status of an operating system.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE DRAWING

Illustrated in the accompanying drawings are the best mode embodiments of the present invention In such drawings:

FIGS. 1 and 2 are logic flow diagrams of the methods of the present invention.

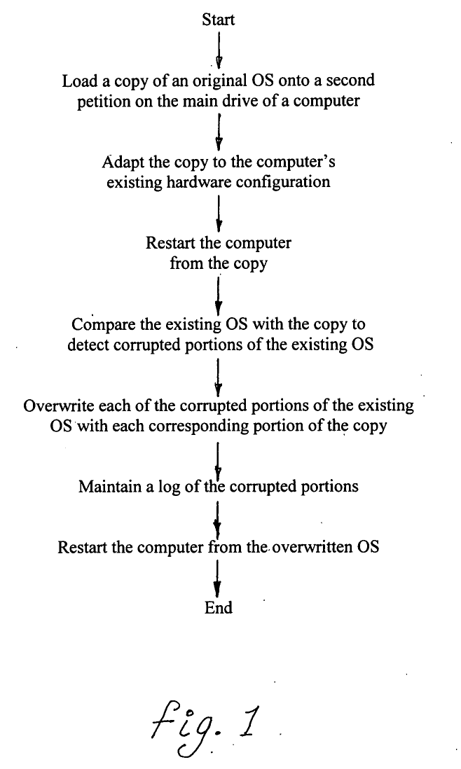

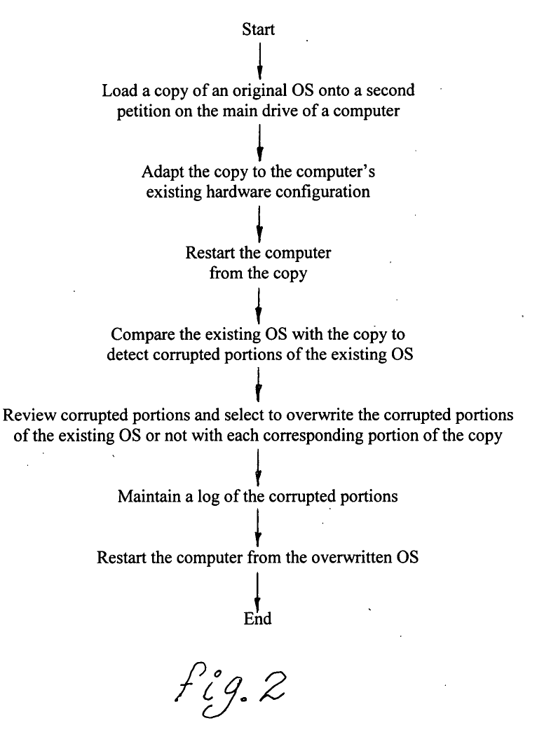

### DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications to what is described herein without departing from its spirit and scope. Therefore, it must be understood that what is illustrated is set forth only for the purposes of example and that it should not be taken as a limitation in the scope of the present apparatus and method of use.

The presently described and illustrated solution to the above described problem is to create an image of the original operating system on the computer's hard drive. Using a comparative algorithm, a file by file comparison is made between the original operating system and the current version in use, checking attributes of all files including: size, function, dates, author, owner, and so on. For each file that differs, the user is notified and asked to approve deletion. This solution is an improvement over conventional methods because it is not selective in nature, it restores everything, even the files that have been wiped out. It restores the operating system to its preferred operating condition.

Described now in detail is a method for achieving the above objectives. The present invention deals with a computer having an operating system that is, or is merely suspected of being, corrupted, referred to herein as the “corrupted OS.” The corrupted OS is stored on a first partition of a main drive of the computer. The computer is enabled for reading a removable data storage device such as a removable disk drive, a CD, DVD, a so called “flash drive” or one or more similar devices. The present method teaches the steps necessary to determine if, in fact, corruption does exist in the corrupted OS, and for de-corrupting the corrupted OS. The term “de-corrupting” is used herein to mean, restoring the corrupted OS to its original state, or to a state that is not necessarily its original state, but also is not considered to be corrupted.

The present method includes, starting the computer from the main drive using the corrupted OS. We assume, here, that the computer is able to be started using the corrupted OS. If not, the computer will need to be started using an original OS installation disk as is well known in the art. Next, the data storage device is engaged with the computer and read. The program on the data storage device directs the determination of the amount of storage space that is being taken by the corrupted OS on the main drive. Next, the program determines the amount of storage space that is open or available for writing to the main drive. Assuming that the open space is sufficient for writing a copy, that is, having about 150% of the space taken by the corrupted OS, a second partition is formed on the main drive, allocating at least 150% of the space taken by the corrupted OS.

Next, the second partition is rendered as the active partition and a copy of the original OS is written to the second partition. This is preferably accomplished by loading an original OS installation disk of the computer.

Next, the original OS is adapted to the existing hardware configuration of the computer, which usually is somewhat different from the hardware configuration of the computer when it was first installed and therefore is not reflected in the original OS.

Next, the computer is restarted from the adapted original OS overwriting the corrupted OS with the adapted original OS. Finally, the first partition is rendered as the active partition and the computer is restarted again running on the de-corrupted OS.

When it is desired to inspect the distinctions between the corrupted OS and the adapted original OS, additional steps are included in the present method. In this case, with the computer operating on the adapted original OS, each distinction found is presented to an operator who is then able to chose to overwrite the corrupted OS with the corresponding portions of the adapted original OS, or to not overwrite.

The specific portions of the corrupted OS that are distinct from the adapted original OS are preferably logged for future reference.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. In a computer having a corrupted operating system stored on a first partition of a main drive, the computer enabled for reading a removable data storage device, a method for de-corrupting the corrupted operating system comprising the steps of:
a) starting the computer from the main drive using the corrupted operating system;
b) reading the data storage device;
c) ascertaining a space requirement for the corrupted operating system;
d) ascertaining an available space on the main drive;
e) creating a second partition on the main drive suitable for receiving a copy of the corrupted operating system;
f) rendering the created partition as active;
g) loading an installation disk having an original operating system;
h) restarting the computer from the installation disk and writing the original operating system to the active partition;
i) adapting the original operating system to a hardware configuration of the computer;
j) restarting the computer enabling operation from the adapted original operating system on the second partition;
k) overwriting the corrupted operating system with the adapted original operating system; and
l) rendering the first partition on the main drive as active before restarting the computer.

2. In a computer having a corrupted operating system stored on a first partition of a main drive, the computer enabled for reading a removable data storage device, a method for de-corrupting the corrupted operating system comprising the steps of:
a) starting the computer from the main drive using the corrupted operating system;
b) reading the data storage device;
c) ascertaining a space requirement for the corrupted operating system;
d) ascertaining an available space on the main drive;
e) creating a second partition on the main drive suitable for receiving a copy of the corrupted operating system;
f) rendering the created partition as active;
g) loading an installation disk having an original operating system;
h) restarting the computer from the installation disk and writing the original operating system to the active partition;
i) adapting the original operating system to a hardware configuration of the computer;
j) restarting the computer enabling operation from the original operating system;
k) comparing the potentially corrupted operating system with the original operating system and overwriting first selected corrupted portions of the corrupted operating system with each corresponding portion of the original operating system;
l) maintaining a log of each said corrupted portion of the corrupted operating system; and
m) rendering the first partition on the main drive as active before restarting the computer.

3. The method of claim 2 further comprising the step of not overwriting second selected portions of the corrupted operating system.

4. In a computer having a corrupted operating system stored on a first partition of a main drive, the corrupted operating system adapted to the existing hardware configuration of the computer, a method for checking the corrupted operating system for corruption and for de-corrupting the existing operating system if necessary, comprising the steps of:
a) loading a copy of an original operating system onto a second partition on the main drive;
b) adapting the copy of the original operating system to the existing hardware configuration;
c) restarting the computer from the copy of the original operating system;
d) comparing the corrupted operating system on the first partition with the copy of the original operating system on the second partition so as to detect corrupted portions of the corrupted operating system;
e) overwriting first selected ones of the corrupted portions of the corrupted operating system with each corresponding portion of the copy of the original operating system;
f) maintaining a log of the corrupted portions; and
g) restarting the computer from the corrupted operating system.

5. The method of claim 4 further comprising the step of not overwriting second selected ones of the corrupted portions of the corrupted operating system.
